(19) United States
(12) Patent Application Publication
(10) Pub. No.: US 2006/0197496 A1
(43) Pub. Date: Sep. 7, 2006

(54) Combination of lithium ion batteries

(75) Inventors: Tsuyoshi Iijima, Tokyo (JP); Kazuya Ogawa, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/347,364

(22) Filed: Feb. 6, 2006

(30) Foreign Application Priority Data
Feb. 4, 2005 (JP) 2005-28338

(51) Int. Cl. H02J 7/00

(52) U.S. Cl. 320/112

(57) ABSTRACT

A combination of lithium ion batteries comprises first and second lithium ion secondary batteries connected in parallel, the first lithium ion secondary battery including an anode active material layer with a thickness in the range of 10 to 40 μm and a cathode active material layer with a thickness in the range of 10 to 40 μm, the second lithium ion secondary battery having a volumetric energy density of 250 Wh/l or more. Therefore, the combination of lithium ion batteries can be charged with less charging time than conventional batteries, and can also ensure a high cycle characteristic and safety.

### BACKGROUND OF THE INVENTION

1. Field of the Invention

The present invention relates to a combination of lithium ion batteries using lithium ion secondary batteries.

2. Related Art

Recent advance in the performances of electronic equipment, particularly of small-sized electronic equipment such as mobile phones, laptop computers, and personal digital assistants (PDAs), has been remarkable, and with widespread use of them, power consumption tends to increase year by year. Lithium ion secondary batteries having high energy densities are widely known as power supplies installed in such electronic equipment (for example, refer to Japanese Patent Laid-Open Publication No. Hei 11-144764).

These conventional lithium ion secondary batteries, however, use a nonaqueous solvent having a large resistance as an electrolyte, so that there has been a problem in that it takes long time to fully charge these batteries. In particular, the lithium ion battery having a high energy density has not only a thick electrode layer but also an active material with a high density. Therefore, when it is rapidly charged with a large current, lithium metal tends to be precipitated on the electrode, leading to the difficulty of enhancing its charge-discharge cycle characteristic and safety.

### SUMMARY OF THE INVENTION

In view of the foregoing problems, various exemplary embodiments of this invention provide a combination of lithium ion batteries that can be charged with less charging time than conventional batteries and can also ensure a high cycle characteristic and safety.

The present inventors, as a result of intensive research, have developed a lithium ion secondary battery capable of being fast-charged and have combined this lithium ion secondary battery with a conventional lithium ion secondary battery having a high energy density to obtain a synergistic effect, thereby having found a combination of lithium ion batteries that can be charged with less charging time than conventional batteries and can also ensure a high cycle characteristic and safety.

In summary, the above-described objectives are achieved by the following embodiments.

(1) A combination of lithium ion batteries comprising a plurality of lithium ion secondary batteries connected in parallel, the plurality of lithium ion secondary batteries including at least a first lithium ion secondary battery having an anode active material layer with a thickness in a range of 10 to 40 μm and a cathode active material layer with a thickness in a range of 10 to 40 μm and a second lithium ion secondary battery with a volumetric energy density of 250 Wh/l or more.

(2) The combination of lithium ion batteries according to (1), wherein the cathode active material layer in the first lithium ion secondary battery 12 is configured to contain a cathode active material comprising a mixed metal oxide represented by the general formula LixMnyNizCol-y-zO2 (where, 0.85≦x<1.1, 0.1≦y≦0.5, and 0.2≦z≦0.8).

(3) The combination of lithium ion batteries according to (1) or (2), wherein the first lithium ion secondary battery comprises a plurality of cells stacked in a thickness direction.

(4) The combination of lithium ion batteries according to any one of (1) to (3), further comprising a third lithium ion secondary battery having the same structure as the second lithium ion secondary battery connected in parallel.

The combination of lithium ion batteries according to the invention has an excellent effect in that it can be charged with less charging time than conventional batteries and can also ensure a high cycle characteristic and safety.

The invention provides a combination of lithium ion batteries that comprises a plurality of lithium ion secondary batteries connected in parallel, the plurality of lithium ion secondary batteries including at least a first lithium ion secondary battery having an anode active material layer with a thickness in the range of 10 to 40 μm and a cathode active material layer with a thickness in the range of 10 to 40 μm and a second lithium ion secondary battery with a volumetric energy density of 250 Wh/l or more, thereby solving the above-mentioned problems.

The terms “anode” and “cathode” according to the invention are defined on the basis of the polarities when a lithium ion secondary battery is discharged. Because of this reason, when charged, “anode” becomes “cathode” and “cathode” becomes “anode.”

### BRIEF DESCRIPTION OF THE DRAWINGS

FIG. 1 is a block diagram schematically showing the basic structure of a combination of lithium ion batteries according to a first exemplary embodiment of the invention;

FIG. 2 is a schematic cross-sectional view taken along the line II-II of the first lithium ion secondary battery in FIG. 1; and

FIG. 3 is a block diagram schematically showing the basic structure of a combination of lithium ion batteries according to a second exemplary embodiment of the invention.

### DESCRIPTION OF THE PREFERRED EMBODIMENTS OF THE INVENTION

The combination of lithium ion batteries according to a first exemplary embodiment of the invention will now be described in detail with reference to the accompanying drawings.

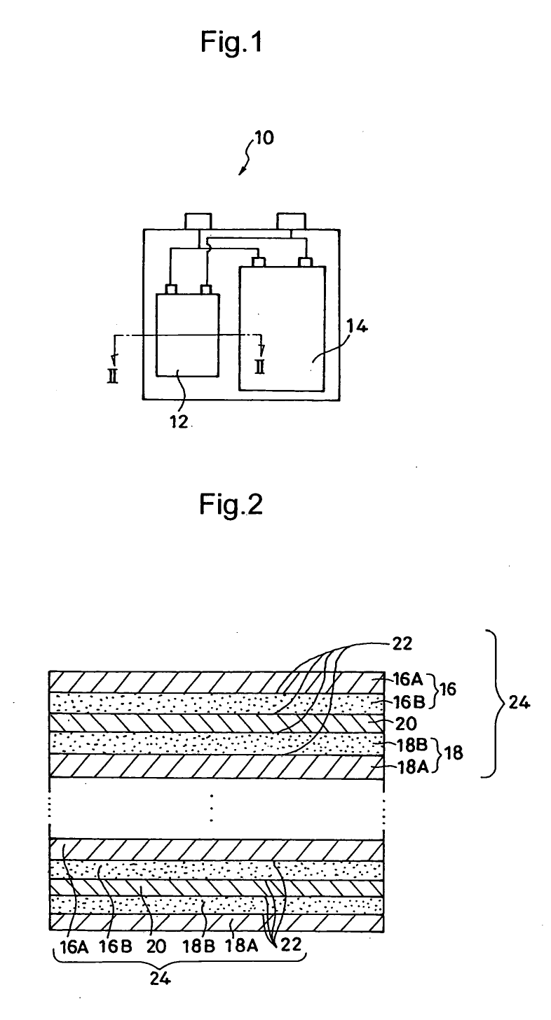

FIG. 1 is a schematic view illustrating the basic structure of the combination of lithium ion batteries 10 according to the first exemplary embodiment of the invention.

As shown in FIG. 1, the combination of lithium ion batteries 10 of the first exemplary embodiment comprises a first lithium ion secondary battery 12 and a second lithium ion secondary battery 14 connected in parallel. For convenience of description, FIG. 1 shows an example in which the first and second lithium ion secondary batteries 12 and 14 are installed adjacent to each other in the width direction, but the invention can be configured to have other arrangements. It is preferable to install the first and second lithium ion secondary batteries 12 and 14 so as to be adjacent to each other in the thickness direction because the combination of lithium ion batteries 10 can be made smaller.

FIG. 2 is a schematic cross-sectional view taken along the line II-II of the first lithium ion secondary battery 12 in FIG. 1.

The first lithium ion secondary battery 12 has a plurality of cells 24 stacked in its thickness direction. The cell 24 comprises a pair of an anode electrode 16 and a cathode electrode 18, a separator 20 sandwiched between the anode and cathode electrodes 16 and 18, and an electrolyte 22 filled in the spaces formed between the anode electrode 16, cathode electrode 18, and separator 20.

The anode electrode 16 comprises a collector layer 16A and an anode active material layer 16B formed on the collector layer 16A. The cathode electrode 18 comprises a collector layer 18A and a cathode active material layer 18B formed on the collector layer 18A.

The collector layers 16A and 18A may be formed of any material that can sufficiently transport electric charges to the anode and cathode active material layers 16B and 18B, respectively, and therefore collector layers used in known lithium ion secondary batteries can be used. The collector layers 16A and 18A include, for example, metal foils such as an aluminum foil, a cupper foil, and other foils.

The anode active material layer 16A of the anode electrode 16 is mainly composed of an anode active material, a conductive auxiliary agent, and a binder, and the thickness of the anode active material layer according to the invention is set to be in the range of 10 to 40 μm.

The anode active material may be formed of any material that can reversibly proceed with lithium ion storage and release, lithium ion extraction and insertion (deintercalation and intercalation), or doping and dedoping of lithium ions with their counter anions (e.g., ClO⁴⁻), including, for example, carbon materials such as meso carbon micro beads (MCMB), natural or artificial graphite, plastic formed carbon, carbon black, carbon fiber, and polyacen, and mixed metal oxides such as lithium titanate.

Examples of the conductive auxiliary agent includes metal powders of a type of carbon black, a carbon material, copper, nickel, stainless steel, iron, and the like, compounds of a carbon material and a metal powder, and conductive oxides such as indium tin oxide (ITO).

The binder may be any material that can bind the particles of the anode active material and conductive auxiliary agent. Examples of the binder include a fluorocarbon resin such as polyvinylidene fluoride (PVDF), polytetrafluoroethylene (PTFE), tetrafluoroethylene-hexafluoropropylene copolymer (FEP), tetrafluoroethylene-perfluoroalkylvinylether copolymer (PFA), ethylene-tetrafluoroethylene copolymer (ETFE), polychlorotrifluoroethylene copolymer (PCTFE), ethylene-chlorotrifluoroethylene copolymer (ECTFE), polyvinyl fluoride (PVF), and the like.

The cathode active material layer 18A of the cathode electrode 18 is mainly composed of a cathode active material, a conductive auxiliary agent, and a binder, and the thickness of the cathode active material layer according to the invention is set to be in the range of 10 to 40 μm.

The cathode active material may be any material that can reversibly proceed with lithium ion storage and release, lithium ion extraction and insertion (deintercalation and intercalation), or doping and dedoping of lithium ions with their counter anions (e.g., ClO⁴⁻). Examples of the cathode active material include lithium cobalt oxide (LiCoO₂), lithium nickel oxide (LiNiO₂), lithium manganese spinel (LiMn₂O₄), a mixed metal oxide represented by the general formula LiNixCoyMnzO2 (where, x+y+z=1), and a mixed metal oxide such as lithium vanadium pentoxide (LiV₂O₅), olivine LiMnPO₄, and lithium titanate spinel (Li₄Ti₅O₁₂). It is preferable to use a mixed metal oxide represented by the general formula LixMnyNizCol-y-zO2 (where, 0.85≦x≦1.1, 0.1≦y≦0.5, and 0.2≦z≦0.8).

As for the constituents other than the cathode active material (i.e., conductive auxiliary agent, binder) contained in the cathode active material layer 18B, the same materials as those contained in the anode active material layer 16B can be used.

The separator 20 sandwiched between the anode electrode 16 and cathode electrode 18 is formed containing an insulative synthetic resin as a constituent material.

The electrolyte 22 can be prepared by dissolving a lithium salt in an organic solvent. Examples of the lithium salt include LiBF₄, LiPF₆, and LiClO₄. The electrolyte 22 may be gelled, for example, by the addition of a gelling agent. The organic solvent can be any solvent used in conventional and known lithium ion secondary batteries, and examples thereof include propylene carbonate, ethylene carbonate, and diethyl carbonate.

The second lithium ion secondary battery 14 can be a conventional and known lithium ion secondary battery, but in the combination of lithium batteries according to the invention, a lithium ion secondary battery having a high volumetric energy density (250 Wh/l or more) is employed.

The present inventors prepared a sample of the lithium ion secondary battery.

First, the anode electrode 16 was fabricated, in which an artificial graphite (90 parts by weight) as an anode active material, carbon black (2 parts by weight) as a conductive auxiliary agent, and polyvinylidene fluoride (PVDF) (8 parts by weight) as a binder were mixed and dispersed into a solvent of N-methyl pyrrolidone (NMP) to obtain a slurry. The obtained slurry was applied to an electrolytic copper foil forming the collector layer 16A by using a doctor blade method, dried at 110° C, and then rolled to obtain the anode electrode 16. In this configuration, the anode active material layer 16B having a thickness of 25 μm was provided on both sides of the collector layer 16A having a thickness of 16 μm, thereby obtaining the anode electrode 16 with a thickness of 66 μm.

Next, the cathode electrode 18 was fabricated, in which LiMn_{1/3}Ni_{1/3}Co_{1/3}O2 (90 parts by weight) as a cathode active material, carbon black (6 parts by weight) as a conductive auxiliary agent, and PVDF (4 parts by weight) as a binder were mixed and dispersed into a solvent of NMP to obtain a slurry. The obtained slurry was applied to an aluminum foil forming the collector layer 18A, dried, and then rolled to obtain the cathode electrode 18. In this configuration, the cathode active material layer 18B having a thickness of 20 μm was provided on both sides of the collector layer 18A having a thickness of 20 μm, thereby obtaining the cathode electrode 18 with a thickness of 60 μm.

Next, the electrolyte 22 was prepared by dissolving LiPF₆ in a solvent with a mol concentration of 1.5 mol/L. The used solvent was prepared by mixing propylene carbonate (PC), ethylene carbonate (EC), and diethyl carbonate (DEC) with a volume ratio of 1:2:7.

Next, the separator (polyolefin separator) 20 was interposed between the anode electrode 16 and cathode electrode 18 to obtain a cell (stack unit) 24. The obtained cells 24 were put in an aluminum laminate pack, which was then filled with the electrolyte 22, vacuum-sealed, and thermally pressed, thereby obtaining the first lithium ion secondary battery 12 with a 3456 size and a capacity of 150 mAh.

Finally, the first lithium ion secondary battery 12 thus obtained and the second lithium ion secondary battery 14 with a length of 33 mm, a width of 53 mm, a thickness of 5.0 mm, and a capacity of 630 mAh were connected in parallel as shown in FIG. 1 and equipped with a circuit configured so that the first lithium ion secondary battery 12 can be charged first, thereby obtaining the combination of lithium ion batteries 10 (sample 1).

The combination of lithium ion batteries 10 of the sample 1 was charged up to a battery voltage of 4.5 V, which required a charging time of about 6 minutes. As a comparative example with respect to the sample 1, the above-mentioned second lithium ion secondary battery 14 was used as a single battery, and charged for 6 minutes (equal to the time required for charging the sample 1) with a current of 1.5 A (comparative example 1).

The combination of lithium ion batteries 10 of the sample 1 and the lithium ion secondary battery 14 of the comparative example 1 were each installed in an identical mobile phone, and the duration of call was measured. As a result, with the sample 1, a call duration of about 30 minutes was obtained, whereas with the comparative example 1, a call duration of only about 7 minutes was obtained. A possible factor causing this result is that in the comparative example 1, when charged with a large current, the charging mode is changed to a constant voltage mode immediately after starting charging and moreover the charging voltage does not reach a sufficient voltage level due to the large battery capacity. Although the sample 1 has nearly the same charging time as the comparative example 1, it allows the duration of call to be as much as about 30 minutes, ensuring a shorter charging time than conventional batteries.

After repeating charging and discharging several ten times, the batteries were decomposed for observation, which revealed that in the comparative example 1, lithium metal precipitated on the cathode electrode was observed, indicating the risk of causing problems with the cycle characteristic and safety. On the other hand, in the sample 1, no precipitation of lithium metal was observed, ensuring an excellent cycle characteristic and safety.

Further, the present inventor collected data for the charging time and cycle characteristic (durability) while changing the thicknesses of the anode and cathode active material layers in the first lithium ion secondary battery.

The results are shown in Tables 1 to 3.

TABLE 1
4.2 V, 5C(750 mA)CCCV charging (End of charging 1/20C)

| Positive | Negative | | |
|---|---|---|---|
| electrode | electrode | | >80% maintained |
| thickness | thickness | Charging time | capacity |
| 20 μm | 20 μm | 20 minutes | >1000 times |
| 30 | 30 | 26 minutes | >1000 |
| 40 | 40 | 29 minutes | 400 |
| 60 | 60 | 43 minutes | 20 |

TABLE 2
4.2 V, 10C(1500 mA)CCCV charging (End of charging 1/20C)

| Positive | Negative | | |
|---|---|---|---|
| electrode | electrode | | >80% maintained |
| thickness | thickness | Charging time | capacity |
| 20 μm | 20 μm | 15 minutes | >1000 times |
| 30 | 30 | 22 minutes | >700 |
| 40 | 40 | 27 minutes | 50 |
| 60 | 60 | 42 minutes | 10 |

TABLE 3
4.5 V, 10C(1500 mA)CC charging

| Positive | Negative | | |
|---|---|---|---|
| electrode | electrode | | >80% maintained |
| thickness | thickness | Charging time | capacity |
| 20 μm | 20 μm | 6 minutes | >600 times |

Table 1 shows the data obtained with constant-current and constant-voltage charging (CCCV charging) at a voltage of 4.2 V and a current of 750 mA. Table 2 shows the data obtained with CCCV charging at a voltage of 4.2 V and a current of 1500 mA. Table 3 shows the data obtained with constant-current charging (CC charging) at a voltage of 4.5 V and a current of 1500 mA. In Tables 1 to 3, the item “positive electrode thickness” corresponds to “cathode active material layer thickness” and the item “negative electrode thickness” corresponds to “anode active material layer thickness.”

As shown in Tables 1 to 3, it has been confirmed that excellent charging times and cycle characteristics are obtained when the thicknesses of the cathode and anode active material layers are in the range of 20 μm to 40 μm. In addition, even in a large current charging at 1500 mA or a high voltage charging at 4.5 V, excellent charging time and cycle characteristic are obtained.

When the thicknesses of the cathode and anode active material layers reach 60 μm, however, the charging time becomes longer and the cycle characteristic deteriorates.

The combination of lithium ion batteries 10 according to the first exemplary embodiment comprises a plurality of lithium ion secondary batteries connected in parallel. The plurality of lithium ion secondary batteries includes at least the following: the first lithium ion secondary battery 12 having an anode active material layer with a thickness in the range of 10 to 40 μm and a cathode active material layer with a thickness in the range of 10 to 40 μm; and the second lithium ion secondary battery 14 with a volumetric energy density of 250 Wh/l or more. Therefore, the combination of lithium ion batteries 10 can require less charging time than conventional batteries, and can also ensure a high cycle characteristic and safety.

The cathode active material layer 18B in the first lithium ion secondary battery 12 is configured to contain a cathode active material comprising a mixed metal oxide represented by the general formula LixMnyNizCol-y-zO2 (where, 0.85≦x≦1.1, 0.1≦y≦0.5, and 0.2≦z≦0.8), so that the withstand voltage can also be increased.

Since the first lithium ion secondary battery 12 comprises a plurality of cells 24 stacked in the thickness direction, the distance between the anode electrode 16 and cathode electrode 18 can be reduced, thereby further improving the charging properties and allowing rapid charging.

The combination of lithium ion batteries according to the invention may be any configuration other than that of the combination of lithium ion batteries according to the first exemplary embodiment described above.

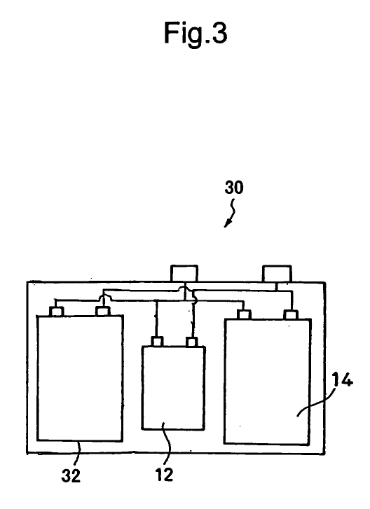

Accordingly, for example, a combination of lithium ion batteries 30 of a second exemplary embodiment, shown in FIG. 3, may be configured such that in addition to the first and second lithium ion secondary batteries 12 and 14, a third lithium ion secondary battery 32 having the same structure as the second lithium ion secondary battery 14 is connected (or, in addition, fourth, . . . , n-th lithium ion secondary batteries are connected) in parallel. The first lithium ion secondary battery 12 may also comprise a single cell 24.

The combination of lithium ion batteries according to the invention is preferably used as a power supply for typical electronic equipment such as, for example, a mobile phone and a personal computer.

What is claimed is:

1. A combination of lithium ion batteries comprising a plurality of lithium ion secondary batteries connected in parallel, the plurality of lithium ion secondary batteries including at least a first lithium ion secondary battery having an anode active material layer with a thickness in a range of 10 to 40 μm and a cathode active material layer with a thickness in a range of 10 to 40 μm and a second lithium ion secondary battery with a volumetric energy density of 250 Wh/l or more.

2. The combination of lithium ion batteries according to claim 1, wherein
the cathode active material layer in the first lithium ion secondary battery 12 is configured to contain a cathode active material comprising a mixed metal oxide represented by the general formula LixMnyNizCol-y-zO2 (where, 0.85≦x≦1.1, 0.1≦y≦0.5, and 0.2≦z≦0.8).

3. The combination of lithium ion batteries according to claim 1, wherein
the first lithium ion secondary battery comprises a plurality of cells stacked in a thickness direction.

4. The combination of lithium ion batteries according to claim 2, wherein
the first lithium ion secondary battery comprises a plurality of cells stacked in a thickness direction.

5. The combination of lithium ion batteries according to claim 1, further comprising a third lithium ion secondary battery having the same structure as the second lithium ion secondary battery connected in parallel.

6. The combination of lithium ion batteries according to claim 2, further comprising a third lithium ion secondary battery having the same structure as the second lithium ion secondary battery connected in parallel.

7. The combination of lithium ion batteries according to claim 3, further comprising a third lithium ion secondary battery having the same structure as the second lithium ion secondary battery connected in parallel.
